(19) United States
(12) Patent Application Publication
(10) Pub. No.: US 2010/0318594 A1
(43) Pub. Date: Dec. 16, 2010

(54) COMPUTING SERVICE SYSTEM AND METHOD FOR EMPLOYING COMPUTING SERVICE

(75) Inventors: CHIA-HUNG CHIEN, Tu-Cheng (TW); CHUN-WEN WANG, Tu-Cheng (TW); LIANG-MAO HUNG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/570,634

(22) Filed: Sep. 30, 2009

(30) Foreign Application Priority Data
Jun. 16, 2009 (CN) 200910303311.4

(51) Int. Cl. G06F 15/16

(52) U.S. Cl. 709/201; 709/218

(57) ABSTRACT

A method is used for employing computing services via a network. The method includes the following steps. A client searches the network and finds out at least two computing services which can be used by the remote connecting module. The at least two computing services includes a first computing service and a second computing service. The client evaluates capabilities of the first computing service and the second computing service respectively. The client checks if the first computing service and the second computing service can finish a task cooperatively. The client composes a task distribution flow according to the capability of the first computing service and the capability of the second computing service. The client distributes the task to the first computing service and the second computing service according to the task distribution flow. The client receives a finished task from the first computing service and the second computing service.

### BACKGROUND

1. Technical Field

The disclosure generally relates to computing service systems and methods for employing computing services, particularly to a computing service system and method for employing computing services via a network.

2. Description of Related Art

Currently, a large number of computers or servers provided by some web sites or individuals are connected to the Internet. However, parts of these computers or servers may be seldom used or perform minor task. These computers or servers may be idle sometimes. It is a waste of computing power to leave these computers and/or servers idle.

### BRIEF DESCRIPTION OF THE DRAWINGS

FIG. 1 is a block view showing computing service system in accordance with embodiments.

FIG. 2 to FIG. 5 are flowcharts showing a method for employing computing service of FIG. 1.

FIG. 6 is a block flowchart of the method of FIG. 2-FIG. 5.

### DETAILED DESCRIPTION

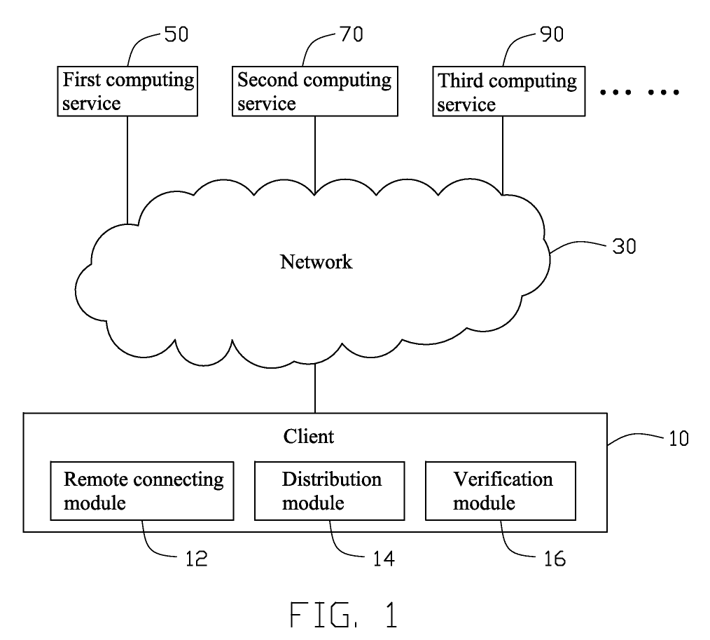

Referring to FIG. 1, a computing service system includes a network 30, a client 10, a first computing service 50, a second computing service 70 and a third computing service 90 respectively connected to the network 30. The network 30 can be one of Internet and Intranet. At least one of the first computing service 50, the second computing service 70 and the third computing service 90 is a remote computer relative to the client 10.

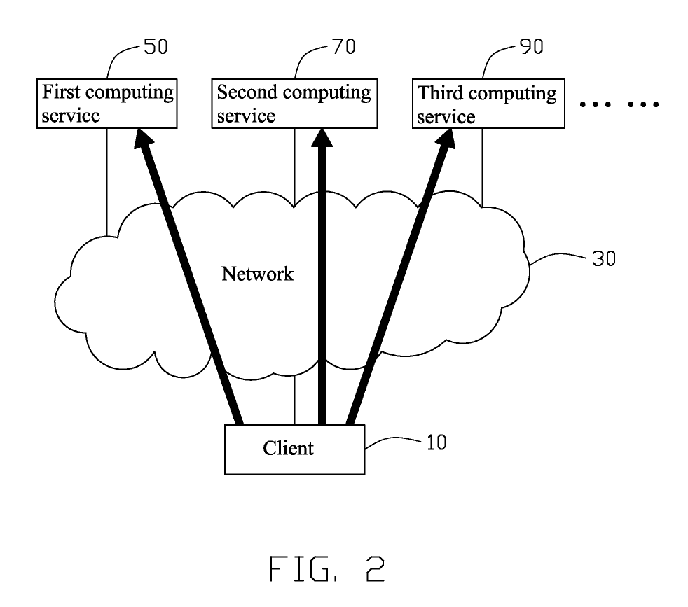

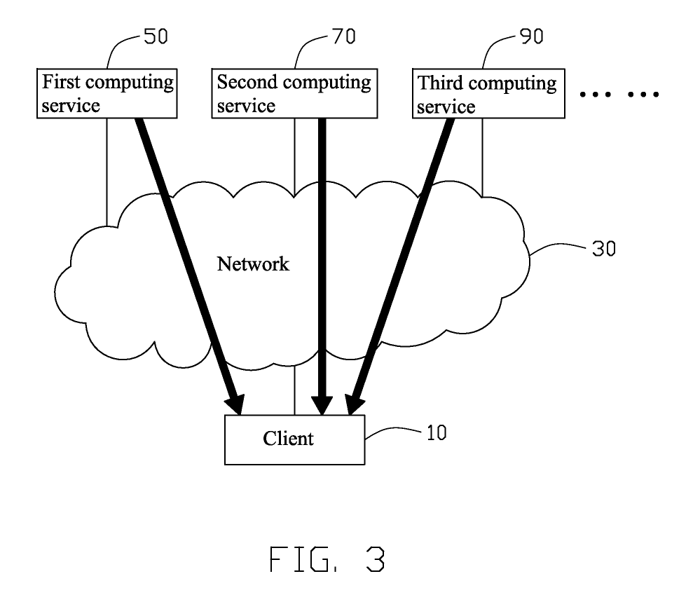

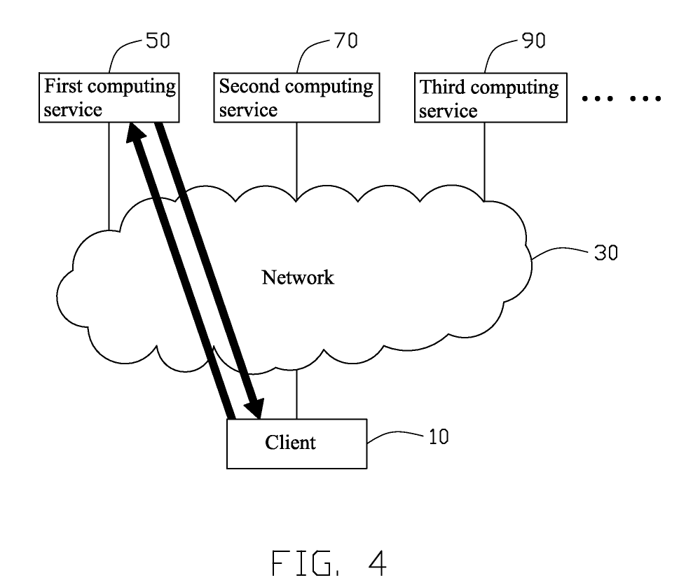

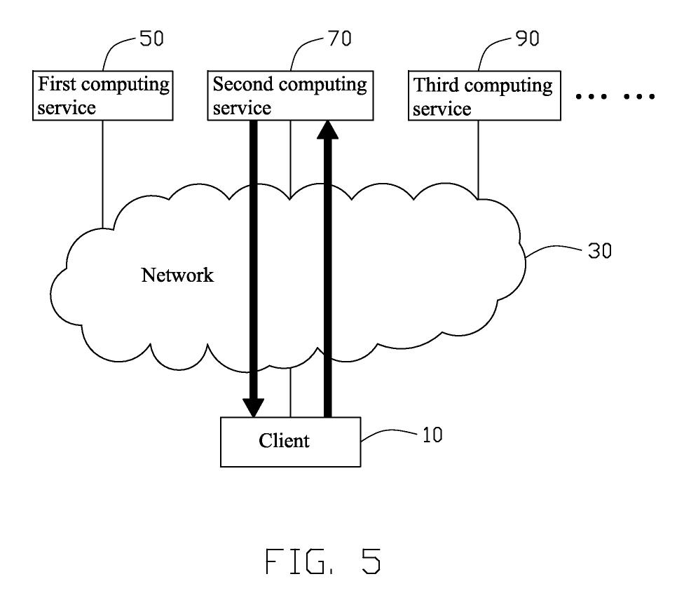

Referring further to FIG. 2 through FIG. 5, the client 10 includes a remote connecting module 12, a distribution module 14 and a verification module 16. The remote connecting module 12 is used to respectively detect the first computing service 50, the second computing service 70 and the third computing service 90 via the network 30 to determine which one or more services is/are capable of being used. In one embodiment, the first computing service 50 and the second computing service 70 are available to the client 10. The remote connecting module 12 can use the first computing service 30 and the second computing service 50 to execute a task. The distribution module 14 can evaluate the capabilities of the first computing service 30 and the second computing service 50. The client 10 can direct the first computing service 30 and the second computing service 50 to execute the task from the client 10 corporately according to their capabilities. Alternatively, when more than two computer services are detected, the distribution module 14 can evaluate the capabilities of all the computer services. The verification module 16 may check the finished task from the first computing service 30 and the second computing service 50.

The distribution module 14 can divide the task into predetermined parts depending on the number of computing computer services. In one embodiment, two computer services are used, so the task is divided into two parts. The distribution module 14 can deliver the divided parts to the first computing service 30 and the second computing service 50 respectively according to their capability. The distribution module 14 can sequentially or synchronously distribute the divided task to the first computing service 30 and the second computing service 50.

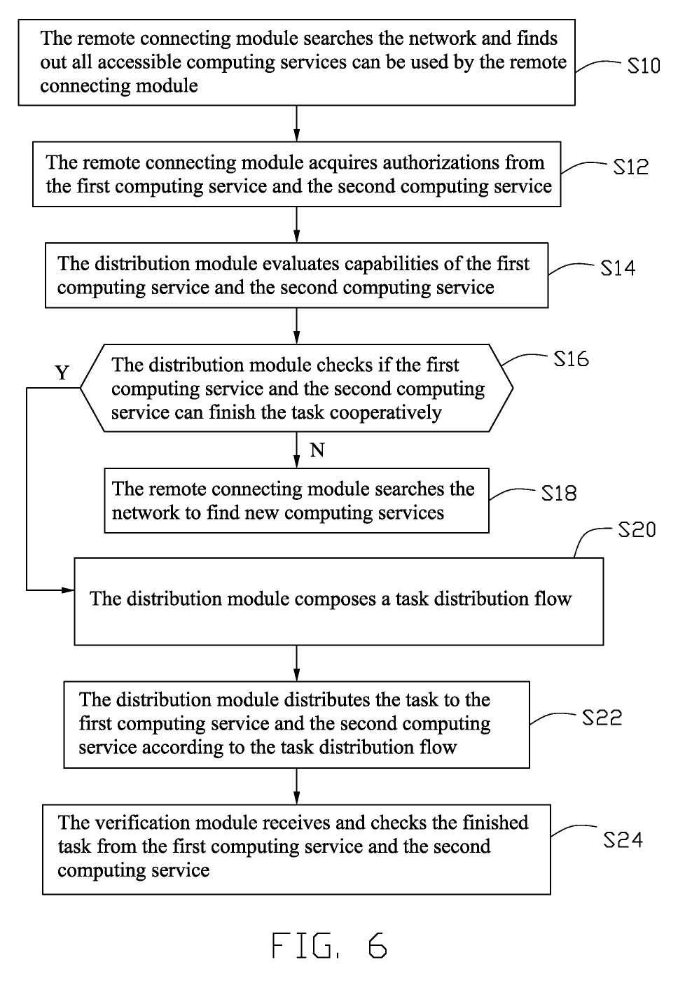

Referring to FIG. 6, a method for employing computing services via the network 30 is shown.

In step 10, the remote connecting module 12 searches the network 30 and finds out all accessible computing services can be used by the remote connecting module 12. In the embodiment, the first computing service 50 and the second computing service 70 are detected and the first computing service 50 and the second computing service 70 can authorize the client 10 to execute the task. In other embodiments, more than two computing services can be used to execute the task.

In step 12, the remote connecting module 12 acquires authorizations from the first computing service 50 and the second computing service 70.

In step 14, the distribution module 14 evaluates capabilities of the first computing service 50 and the second computing service 70.

In step 16, the distribution module 14 checks if the first computing service 70 and the second computing service 90 can finish the task cooperatively, if yes, go to step 20; if no, go to step 18.

In step 18, the remote connecting module 12 searches the network to find new computing services.

In step 20, the distribution module 14 composes a task distribution flow according to the capability of the first computing service 50 and the capability of the second computing service 70.

In step 22, the distribution module 14 distributes the task to the first computing service 30 and the second computing service 50 according to the task distribution flow. The task distribution flow may include an execution sequence to the first computing service 30 and the second computing service 50, and a first workload coupled to the first computing service 30 and a second workload coupled to the second computing service 50.

In step 24, the verification module 16 receives and checks the finished task from the first computing service 30 and the second computing service 50 after the first computing service 30 and the second computing service 50 finishes the task.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A method for employing computing services via a network, the method comprising:
searching the network and finding out at least two computing services which can be used by the remote connecting module, the at least two computing services comprising a first computing service and a second computing service;
evaluating capabilities of the first computing service and the second computing service respectively;
checking if the first computing service and the second computing service can finish a task cooperatively;
composing a task distribution flow according to the capability of the first computing service and the capability of the second computing service, if the first computing service and the second computing service can finish the task cooperatively;
distributing the task to the first computing service and the second computing service according to the task distribution flow; and
receiving a finished task from the first computing service and the second computing service.

2. The method of claim 1 further comprising: checking the finished task after receiving the finished task.

3. The method of claim 1, wherein the task distribution flow comprises an execution sequence to both the first computing service and the second computing service.

4. The method of claim 1, wherein the task distribution flow comprises a first workload coupled to the first computing service and a second workload coupled to the second computing service.

5. The method of claim 1, wherein at least one of the first computing service and the second computing service is a remote computer.

6. The method of claim 1 further comprising acquiring authorizations from the first computing service and the second computing service before evaluating the capabilities of the first computing service and the second computing service.

7. The method of claim 1, wherein the network is one of the Internet and an intranet.

8. A computing service system comprising:
a client comprising a remote connecting module and a distribution module, the remote connecting module capable of accessing a first computing service and a second computing service through a network and evaluating capabilities of the first computing service and the second computing service;
wherein the client is capable of directing the first computing service and the second computing service to execute a task from the client corporately according to the capabilities.

9. The computing service system of claim 8, wherein the client further comprises a verification module, and the verification module is capable of checking a finished task from the first computing service and the second computing service.

10. The computing service system of claim 8, wherein the distribution module is capable of dividing the task into predetermined parts depending on the number of computing computer services, and the distribution module is capable of delivering the divided parts to the first computing service and the second computing service respectively according to the capability of the first computing service and the capability of the second computing service.

11. The computing service system of claim 10, wherein the distribution is capable of sequentially distributing the divided task to the first computing service and the second computing service.

12. The computing service system of claim 8, wherein at least one of the first computing service and the second computing service is a remote computer.

13. The computing service system of claim 8, wherein the remote connecting module is capable of acquiring authorizations from the first computing service and the second computing service.

14. The computing service system of claim 8, wherein the network is one of the Internet and an intranet.
